(19) United States
(12) Patent Application Publication
(10) Pub. No.: US 2012/0121999 A1
(43) Pub. Date: May 17, 2012

(54) CELL OF A HIGH TEMPERATURE FUEL CELL WITH INTERNAL REFORMING OF HYDROCARBONS

(75) Inventors: Jéôme Laurencin, Sassenage (FR); Richard Laucournet, La Buisse (FR); Julie Mougin, Pontcharra (FR)

(73) Assignee: Commissariat a l'energie atomique et aux energies alternatives, Paris (FR)

(21) Appl. No.: 13/320,016

(22) PCT Filed: May 10, 2010
(86) PCT No.: PCT/EP2010/056376

§ 371 Date: Jan. 30, 2012

(30) Foreign Application Priority Data
May 11, 2009 (FR) 0953109

(51) Int. Cl. H01M 8/06; H01M 8/10

(52) U.S. Cl. 429/423; 429/480

(57) ABSTRACT

It relates to a solid oxide fuel cell (SOFC) with internal reforming of hydrocarbons, in which said cell is a metal-supported cell comprising a porous metallic support comprising pores having walls, said porous support comprising a first main surface and a second main surface, an anode adjacent to said second main surface, an electrolyte adjacent to said anode, and a cathode adjacent to said electrolyte, a catalyst for reforming at least one hydrocarbon being deposited on the walls of the pores of the porous metallic support, and the amount and concentration of catalyst in the porous metallic support decreasing in a direction from the first main surface in the same direction as a flow direction of a hydrocarbon feed stream, along said first main surface on the outside of the cell.

### TECHNICAL FIELD

The invention relates to a cell of a high temperature, solid oxide fuel cell (SOFC), more specifically a cell of a metal-supported solid oxide fuel cell (MSC or metal-supported cell), in which internal reforming of hydrocarbons such as natural gas is carried out.

The technical field of the invention may thus be defined generally as that of novel energy technologies, more particularly as that of solid oxide fuel cells (SOFCs) and more specifically still as that of cells of metal-supported solid oxide fuel cells.

### PRIOR ART

Metal-supported cells are considered, for the SOFC application, to be third generation cells (electrolyte-supported cells forming generation 1 and anode-supported cells generation 2) [1].

The first generation of cells of High Temperature Electrolyzers (or Solid Oxide Electrolysis Cells) or solid oxide fuel cells comprised a support formed by the electrolyte and was thus referred to as an electrolyte-supported cell (ESC). Such an electrolyte-supported cell is represented in FIG. 1: the oxygen O₂ electrode (1) and the hydrogen or water electrode (2) are arranged on either side of the thick electrolyte which constitutes the support (3).

The second generation of cells of High Temperature Electrolyzers (Solid Oxide Electrolysis Cells) or of solid oxide fuel cells comprised a support formed by an electrode and was thus referred to as an anode-supported cell (ASC) in SOFC terminology or as a cathode-supported cell (CSC) in “HTE” (SOEC) terminology. Such an ASC or CSC electrode-supported cell is represented in FIG. 2: the electrolyte (3) and the oxygen electrode (1) are arranged on the thick hydrogen or water electrode (2) which acts as a support.

The third generation of cells of High Temperature Electrolyzers (Solid Oxide Electrolysis Cells) or of solid oxide fuel cells, which will be dealt with more particularly in the present text, comprises a porous metallic support and is therefore referred to as a metal-supported cell (MSC). Such a metal-supported cell may be in the form of two configurations which are respectively represented in FIGS. 3A and 3B depending on whether the electrode which is placed in contact with the porous metallic support is the hydrogen or water electrode (2) (FIG. 3A) or else the oxygen electrode (1) (FIG. 3B). Further details on these various types of “HTE” (SOEC) and “SOFC” can be found in document [1].

The metal-supported cells represented in FIGS. 3A and 3B comprise four layers (including one metallic layer and three ceramic layers), namely:
the porous metallic support (4), generally having a thickness less than 1 mm which provides:
   the mechanical support of the cell owing to its mechanical properties and to its thickness,
   the distribution of the gases up to the electrode for the electrochemical reactions owing to its porosity,
   current collecting owing to its conductive metallic nature,
the H₂/H₂O electrode (2) which is the anode for an SOFC and the cathode for an “HTE” (SOEC). Owing to the metallic support (4), this electrode may be made thinner, with for example a thickness of less than 50 μm, its resistance to redox cycles is thus better and its cost is lower;
the electrolyte (3), ion conductor for O² ions. The electrolyte (3) may be made thinner, with for example a thickness of less than 10 μm, its operating temperature may thus be lowered;
the O₂ electrode (1) which is the cathode for an SOFC, and the anode for an “HTE” (SOEC). This electrode (1) may be made thinner with for example a thickness of less than 50 μm.

It should be noted that the thicknesses given in FIG. 3B are mentioned only by way of example.

The present application relates more particularly to a cell having the configuration shown in FIG. 3A, in which the cell consists of a dense electrolyte layer (3), for example made of zirconia stabilized with yttrium oxide (YSZ), with scandium oxide, with ytterbium oxide or with gadolinium oxide inserted between a porous cathode (1), for example made of strontium-doped lanthanum manganite (LSM), and an anode for example made of a cermet of nickel and of zirconia stabilized with yttrium oxide (denoted by Ni-YSZ) or stabilized with scandium, ytterbium or gadolinium oxide.

The stack of the cathode (1), of the electrolyte (3) and of the anode (2) is deposited onto the porous metallic support (4).

In FIG. 4, in which the cell has the configuration from FIG. 3A, the porous metallic support has been represented in greater detail showing the pores (5) in the metallic phase (6).

The main advantages of this type of architecture of a metal-supported cell are the following:
It makes it possible to reduce the operating temperature of SOFCs to between 500° C. and 800° C. [2,3]. The electrochemical performances of this cell architecture have been evaluated under hydrogen. The thinness of the electrolyte inherent to this type of architecture makes it possible to achieve the high electrochemical performances required for SOFC applications. By way of example, M. C. Tucker et al. [4] published cell performances obtained under hydrogen at 750° C. that reach ˜1100 mA·cm⁻² at 0.7 volt.
As mentioned by numerous authors, the replacement of the ceramic support with a metallic support increases the mechanical robustness of the cells. It has thus been demonstrated that metal-supported cells are capable of withstanding rapid thermal cycles. Y. B. Matus et al. [3] have, for example, cycled cells 50 times between 200° C. and 800° C. at 50° C.·min⁻¹. The observations showed that only the material used for sealing the cells was damaged. P. Attryde et al. [2] have, for their part, cycled cells welded into their support 500 times between 20° C. and 600° C. at 120° C.·min⁻¹. Once again no rupture was mentioned.
This type of metal-supported architecture also appears to be tolerant to alternations between an oxidizing atmosphere and a reducing atmosphere in the anode compartment. These alternations between oxidizing conditions and reducing conditions are also referred to as “redox” cycles. This tolerance of the metal-supported architecture with respect to alternations between an oxidizing atmosphere and a reducing atmosphere has recently been demonstrated by M. C. Tucker et al. [5]. These authors subjected on the one hand, a metal-supported type cell and, on the other hand, an anode-supported type cell to five “redox” cycles. At each cycle, the nickel-based cermet constituting the anode was completely reoxidized. While the thin electrolyte of the anode-supported cell is broken from the first reoxidation of the nickel, the metal-supported cell continues to operate after the five cycles. A drop in the electrochemical performances under hydrogen is nevertheless observed, passing from 650 mW·cm⁻² to 475 mW·cm⁻² (at 0.7 volts and 700° C.)

The main drawback of the metal-supported architecture lies in the slow corrosion of the porous metallic support even under reducing conditions.

The ideal fuel on the anode side is hydrogen, but its flammability, and the problems linked to its storage and to its distribution greatly complicate its use. Consequently, it is advantageous to use hydrocarbons such as natural gas, gases resulting from biomass, petrol, and diesel fuel for feeding the solid oxide fuel cells (SOFCs).

The use of these hydrocarbons requires a reforming step in order to convert the hydrocarbons into a mixture containing hydrogen, CO and CO₂ which is then sent to the anode side of the fuel cell.

External reforming processes upstream of the fuel cell comprise, for example, catalytic partial oxidation (CPDX); autothermal reforming (ATR) and steam reforming (SR).

These processes are said to be “external” reforming processes because they are carried out outside of the fuel cell. Therefore, they increase the cost, the volume and the complexity of the entire plant. Moreover, they often result in additional energy consumption in order to convert the hydrocarbons. Thus, external steam reforming is an endothermic process which requires a heat source with an additional fuel consumption. Or else, the thermal energy released by the SOFC fuel cell may be used to maintain the steam reforming reaction by means of a heat exchanger, which is also very expensive.

This is why it has turned out to be very advantageous to carry out the reforming of hydrocarbons inside the fuel cell via “internal reforming” or more specifically by “direct internal reforming” (DIR).

Thus, direct internal reforming (DIR) of methane or natural gas has been widely studied.

One of the advantages of DIR is in using the heat produced by the electrochemical oxidation of hydrogen in order to carry out the endothermic reforming reaction. Nevertheless, this process may induce significant heat gradients if the cell does not have a high thermal conductivity.

The steam reforming reaction takes place at the surface of the solid and requires the use of a catalyst.

It has been shown that nickel [6,7] or metals such as Pt, Ru, Pd, Rh or Ir, incorporated into an oxide support [8, 9] are very good catalysts for reforming reactions. By way of illustration, a method has been proposed for forming an anode having a high porosity to which a precious metal is added in order to increase the catalytic surface and the reactivity with respect to reforming reactions [10].

Moreover, sulphur-containing species such as H₂S, contained in the form of traces or additives in the natural gas, may be adsorbed onto the sites for reforming and for electro-oxidation of hydrogen. Hydrogen sulphide may thus participate in the poisoning of the anode [11, 12].

However it has been shown [9] that platinum, when it is incorporated into a gadolinium-doped ceria (CGO) exhibits a high tolerance with respect to the H₂S content of the fuel gas.

The anode of a cell of a SOFC conventionally consists of a mixture of nickel and of yttried zirconia, namely an Ni-YSZ cermet, with generally 40 vol % of Ni and 60 vol % of YSZ, generally having a porosity of around 40%.

For such an anode, J. Laurencin et al. [13] have shown that the DIR of methane requires a large reaction volume in order to ensure sufficient hydrogen production from the cell inlet onwards: the anodic cermet must therefore have a thickness greater than 400 μm so that the DIR of the methane is not a limiting process. This study has furthermore shown that the reforming is mainly localized at the cell inlet.

Generally, for efficient operation of the fuel cell, the DIR of natural gas must be carried out with a system having, inter alia, the following features:
(1) large enough reaction volume, generally defined by a thickness of the reaction layer of greater than 400 μm, necessary for the steam reforming reaction;

(2) use of an efficient and sulphur-resistant steam reforming catalyst;

(3) good thermal conductivity of the cell;

(4) resistance of the anode with respect to sulphur poisoning;

(5) good mechanical strength of the cell under the effect:
of thermal cycles and oxidation-reduction cycles of the cermet during the on/off sequences of the system,
of a temperature gradient when operating under methane.

Furthermore, with regard to the high cost of reforming catalysts which are generally based on noble metals, it is desired to optimize the amounts of catalyst used while ensuring a sufficient conversion of the hydrocarbons, such as methane, into hydrogen.

The use of a conventional anode-supported cell made of Ni-YSZ cermet, optionally impregnated with a sulphur-resistant steam reforming catalyst, makes it possible to satisfy the first two points from this specification. However, this anode-supported cell architecture has a weak mechanical robustness, which could be limiting under the effect of a significant temperature gradient. Furthermore, as already mentioned, the Ni-YSZ cermet is rapidly poisoned by hydrogen sulphide and thus loses its electrocatalytic activity (oxidation of hydrogen). Furthermore, the anode-supported cell is not very mechanically resistant during “redox” cycles of the cermet [17].

Patents and patent applications [14, 15, 16] are found in the literature that relate to the use no longer of the anode but of metallic interconnectors as sites of reforming reactions. It is recalled that these interconnectors act as a current collector and ensure the distribution of gases to the cell.

Liu et al. [15] propose, for example, an innovative geometry of gas distributors covered by the steam reforming catalyst.

K. Hoshino et al. [16] suggest using porous metals that ensure the diffusion of the gases to the electrodes. In this concept, the conventional anode-supported or electrolyte-supported cell, and not metal-supported cell, is therefore held between two porous metals. The author mentions a very large average pore size, namely around 300 μm, which is essential for ensuring an effective distribution of the gases to the cell. On the anode side, the porous metal is partially filled with catalyst in order to provide the reforming function. This type of architecture has however a certain number of drawbacks:
1) On the cathode side, the porous metal could oxidize rapidly in air at high temperature.
2) This solution uses conventional anode-supported or electrolyte-supported cells: consequently, this system remains greatly limited by the high mechanical brittleness inherent in these types of cells.
3) In this type of approach, the distribution of the catalyst is not optimized and results in the use of a large amount of noble metals and therefore in an increase in the costs.
4) The efficiency of the current collecting is limited by the very high porosity of the gas distributor.

With regard to the foregoing, there is therefore a need for a cell of a solid oxide fuel cell with internal reforming of hydrocarbons which meets all the requirements and all the criteria listed above as regards, in particular, sufficient reaction volume for the reforming reaction, especially the steam reforming reaction; efficiency of the reforming catalyst; sulphur resistance of the reforming catalyst; good thermal conductivity of the cell; resistance of the anode to poisoning by sulphur; good mechanical resistance of the cell under the effect of thermal cycles and oxidation-reduction cycles of the cermet during on/off sequences of the system, and of a temperature gradient when operating under a hydrocarbon such as methane; optimization of the amount of catalyst while guaranteeing a sufficient conversion of the hydrocarbon such as methane into hydrogen.

### SUMMARY OF THE INVENTION

The goal of the present invention is to provide a cell of a solid oxide fuel cell with internal reforming of hydrocarbons which meets, inter alia, all the needs listed above, and which satisfies, inter alia, all of the criteria and requirements mentioned above for such a cell of a fuel cell with internal reforming of hydrocarbons.

Another goal of the present invention is to provide a cell of a solid oxide fuel cell with internal reforming of hydrocarbons which does not have the drawbacks, defects, limitations and disadvantages of cells of solid oxide fuel cells with internal reforming of hydrocarbons of the prior art, and which solves the problems of the cells of the prior art.

This goal, and others too, are achieved in accordance with the invention by a cell of a solid oxide fuel cell (SOFC) with internal reforming of hydrocarbons, in which said cell is a metal-supported cell comprising:
a porous metallic support comprising pores having walls, said porous support comprising a first main surface and a second main surface;
an anode adjacent to said second main surface;
an electrolyte adjacent to said anode; and
a cathode adjacent to said electrolyte;

a catalyst for reforming at least one hydrocarbon being deposited on the walls of the pores of the porous metallic support, and the amount, concentration of catalyst in the porous metallic support decreasing in a direction of the first main surface in the same direction as a flow direction of a hydrocarbon feed stream, along said first main surface on the outside of the cell.

The cell of a fuel cell according to the invention has never been described in the prior art as represented in particular by the documents cited above.

In particular, the incorporation of a catalyst into the porous metallic support of a cell of a metal-supported fuel cell is neither mentioned nor suggested in the prior art.

It may be said that the basic principle of the present invention is to functionalize the porous metallic substrate of a metal-supported cell of a fuel cell in order to carry out the direct internal reforming of a hydrocarbon, such as methane.

According to the invention, use is surprisingly made of the volume of the porous metallic support of a cell of a fuel cell, previously impregnated with a reforming catalyst in order to ensure a non-limiting conversion of a hydrocarbon such as methane into hydrogen.

The cell of a fuel cell according to the invention does not have the drawbacks, defects and disadvantages of cells of solid oxide fuel cells with internal reforming of hydrocarbons of the prior art, fulfils all the criteria and meets all the requirements listed above for these cells, and provides a solution to all the problems of the cells of fuel cells of the prior art.

Among the advantageous properties that the cell of a fuel cell according to the invention has, mention may especially be made of the following:
The great mechanical robustness of metal-supported cells is benefitted from in an extremely advantageous manner by the cells according to the invention within the context of the targeted application, namely the direct internal reforming of hydrocarbons;
In the cell according to the invention, the volume of the metallic support is used as the site of the reforming of hydrocarbons, for example methane, thus separating, unlike the cells of the prior art, the role of electrode from that of reformer. The high thermal conductivity of the metal ensures the transport of heat within the cell, necessary for the reforming of the hydrocarbons, for example methane. It will make it possible to limit the temperature gradients when operating;
The impregnation of the porous support by a catalyst, such as a Pt/CGO catalyst, makes it possible to obtain the efficiency necessary for obtaining a high degree of conversion of the methane.

Generally, there is preferably a single feed stream with preferably a single flow direction.

Advantageously, the first main surface and the second main surface may be flat and parallel surfaces. And the substrate is therefore then a planar substrate.

Advantageously, the first main surface may be a lower surface and the second main surface may be an upper surface, and the anode, electrolyte and cathode are successively stacked onto the second main surface of the porous metallic support.

Advantageously, the porosity of the porous metallic support may be from 20 to 70%, for example 40%.

Advantageously, the average diameter of the pores of the porous metallic support may be from 1 to 50 μm, preferably from 5 to 15 μm, for example 6 μm.

Advantageously, the thickness of the porous metallic support, defined by the distance between the first main surface and the second main surface of the porous metallic support, may be from 200 to 1000 μm, preferably from 400 to 500 μm.

Advantageously, if the porous metallic support has a porosity, and/or an average radius of the pores, and/or a thickness which are in the ranges defined above, and if preferably the porosity and the average radius of the pores and the thickness all three simultaneously lie within these ranges, then the amount of catalyst used is optimized, the use of expensive noble metals is limited, and the dimensions of the support are generally sufficient for the DIR of a hydrocarbon such as methane to be carried out.

Advantageously, the amount of catalyst may be from 0.1 to 5% by weight relative to the weight of the porous metallic support.

Advantageously, the catalyst may be a steam reforming catalyst.

Advantageously, the catalyst is chosen from transition metals such as nickel, cobalt, copper, chromium and iron; noble or precious metals such as ruthenium, platinum, rhodium, iridium, silver and palladium; and mixtures thereof.

The catalyst may be supported, impregnated on a solid support.

Advantageously, the solid support of the catalyst may be chosen from optionally doped metal oxides, such as alumina; strontium-doped lanthanum chromite; and ceria, optionally doped with gadolinium, samarium or yttrium.

One preferred catalyst is a noble metal such as platinum supported by gadolinium-doped ceria (CGO) preferably of formula Ce_{0.8}Gd_{0.2}O_{1.9}.

Advantageously, the catalyst in particular supported on its support such as the Pt/Gd-doped ceria catalyst for example, may be in the form of particles.

The particles, preferably spherical particles, may have a size, for example a diameter, from 20 nm to 1 μm.

Owing to its oxide support (made of “CGO” for example) the catalyst (Pt for example) will not be adversely affected by the slow corrosion at the surface of the metallic phase of the support.

Furthermore, it has been observed that these Pt/CGO particles do not lose their catalytic activity in the presence of hydrogen sulphide.

Moreover, these particles make it possible, in the manner of the porous nickel layer, to trap H₂S.

The catalyst, for example in the form of particles and in particular in the form of a powder, may at least partially fill the pores of the porous metallic support and may be deposited on the walls of the pores of the porous metallic support.

Advantageously, the amount, concentration of catalyst decreases continuously or in decrements in the porous metallic support from a first end of the latter where an inlet for the feed stream of said hydrocarbon is located to a second end of the latter where an outlet for discharging a stream of at least one reforming product is located.

Thus, the porous metallic support may be divided into n successive zones from said first end to said second end, the amount, concentration of catalyst being decreased each time, preferably divided by an integer, for example 2 or 3, from one zone to the next.

The man skilled in the art will be able to adapt the number of zones, defined by the value of n, depending on the requirements.

n is an integer which may range for example from 2 to 10. In practice, for n>3, the n^{th} zone may optionally be free of catalyst, without the performances of the cell being adversely affected thereby.

For example, the porous metallic support may be divided into a first, a second and a third successive zones, preferably of equal volume, from said first end to said second end, the amount of catalyst in said second zone, respectively third zone, being half of the amount of catalyst in said first zone, respectively second zone.

Indeed, it has been shown that the reforming should be considerable starting from the inlet of the cell since a sufficient amount of hydrogen is thus provided for an efficient use of the complete surface of the cell. Consequently, it is advantageous to functionalize the porous metallic support with a catalyst gradient in the longitudinal direction, that is to say generally in the direction of the first main surface and/or of the second main surface in the flow direction of a feed stream of fuel, in particular of fuel gas, along the cell, on the outside thereof.

Such a catalyst gradient, advantageously combined with an optimized thickness of the porous metallic support preferably lying within the range mentioned above, also makes it possible to optimize and reduce to the necessary minimum the amount of catalyst, and in particular the amount of noble metals used.

Advantageously, the porosity of the porous metallic support may decrease from the first main surface to the second main surface, and the support may then comprise, from the first main surface to the second main surface, at least one layer of high porosity in contact with the first main surface and a layer of low porosity in contact with the second main surface.

Advantageously, the cell of a fuel cell according to the invention may comprise, in addition, a porous layer made of a metal chosen from nickel, copper, manganese, cobalt, iron and alloys thereof, deposited on the first main surface.

Preferably, this porous layer is made of nickel, more preferably made of pure nickel.

Advantageously, this nickel layer has a thickness of around 10 to 20 μm.

This layer of metal, preferably of nickel, makes it possible to trap H₂S and to protect the anode, for example made of an Ni-YSZ cermet, against sulphur poisoning.

This layer of metal, preferably of nickel, also acts as a protective layer during the reoxidation of the anode. Indeed, by acting as an oxygen trap at the inlet to the cell, it limits the oxidation of the anode, for example made of an Ni-YSZ cermet.

In other words, this layer makes it possible to increase the sulphur content which can be accepted by the fuel cell and to improve the resistance of the fuel cell to “redox” cycling.

Advantageously, the porous metallic support may be made of a metal or alloy chosen from iron, iron-based alloys, chromium, chromium-based alloys, iron-chromium alloys, stainless steels, nickel, nickel-based alloys, nickel-chromium alloys, alloys containing cobalt, alloys containing manganese, aluminium, and alloys containing aluminium.

Advantageously, the anode may be made of a cermet of nickel and of yttrium oxide-stabilized zirconia (YSZ), or of a cermet of nickel and of ceria stabilized, doped with scandium, ytterbium or gadolinium oxide. For example, the oxide may be a cermet of nickel and of zirconia stabilized with 8 mol % of yttrium oxide (Ni-8YSZ), or made of a cermet of nickel and of gadolinium-doped ceria (CGO).

The cermet made of Ni-gadolinium oxide-doped ceria (Ni-CGO), which is more tolerant than the Ni-YSZ cermet with respect to sulphur-containing compounds such as H₂S, thus improves the resistance of the anode with respect to sulphur, and improves it even more when there is also provided a porous layer of metal, preferably of nickel, on the second main surface of the porous metallic support.

### BRIEF DESCRIPTION OF THE DRAWINGS

FIG. 1 is a schematic vertical cross-sectional view of an electrolyte-supported cell (“ESC”) of an “HTE” (“SOEC”) or “SOFC”;

FIG. 2 is a schematic vertical cross-sectional view of an electrode-supported cell (anode-supported: “ASC” in “SOFC” designation or cathode-supported: “CSC” in “HTE” (SOEC) designation) of an “HTE” (SOEC) or SOFC;

FIG. 3A is a schematic vertical cross-sectional view of a metal-supported cell (“MSC”) of an “HTE” (SOEC) or “SOFC” in a first configuration in which the electrode which is placed in contact with the porous metallic support is the hydrogen or water electrode;

FIG. 3B is a schematic vertical cross-sectional view of a metal-supported cell (“MSC”) of an “HTE” (SOEC) or “SOFC” in a second configuration in which the electrode which is placed in contact with the porous metallic support is the oxygen electrode;

FIG. 4 is a schematic vertical cross-sectional view of a metal-supported cell of a SOFC having the configuration from FIG. 3A, comprising a porous metallic support, on which the pores of this support have been represented;

FIG. 5 is a schematic vertical cross-sectional view of a metal-supported cell of a SOFC according to the invention in which the porous metallic support is infiltrated by catalyst particles, such as particles of ceramic oxide impregnated by a noble metal, for example Pt/CGO;

FIG. 6 is a schematic vertical cross-sectional view of a metal-supported cell of a SOFC according to the invention in which the porous metallic support is infiltrated by catalyst particles, and in which, in addition, a porous layer of nickel is deposited on the lower surface of the porous metallic support;

FIG. 7 is a schematic vertical cross-sectional view of a metal-supported cell of a SOFC according to the invention in which the porous metallic support is infiltrated by catalyst particles, in which, in addition, a porous layer of nickel is deposited on the lower surface of the porous metallic support. The catalyst is distributed in the metallic support with a longitudinal concentration gradient that decreases from the inlet to the outlet of the gases;

FIG. 8 is a flow chart which shows the various processes for producing a functionalized porous metallic support of a cell of a fuel cell according to the invention.

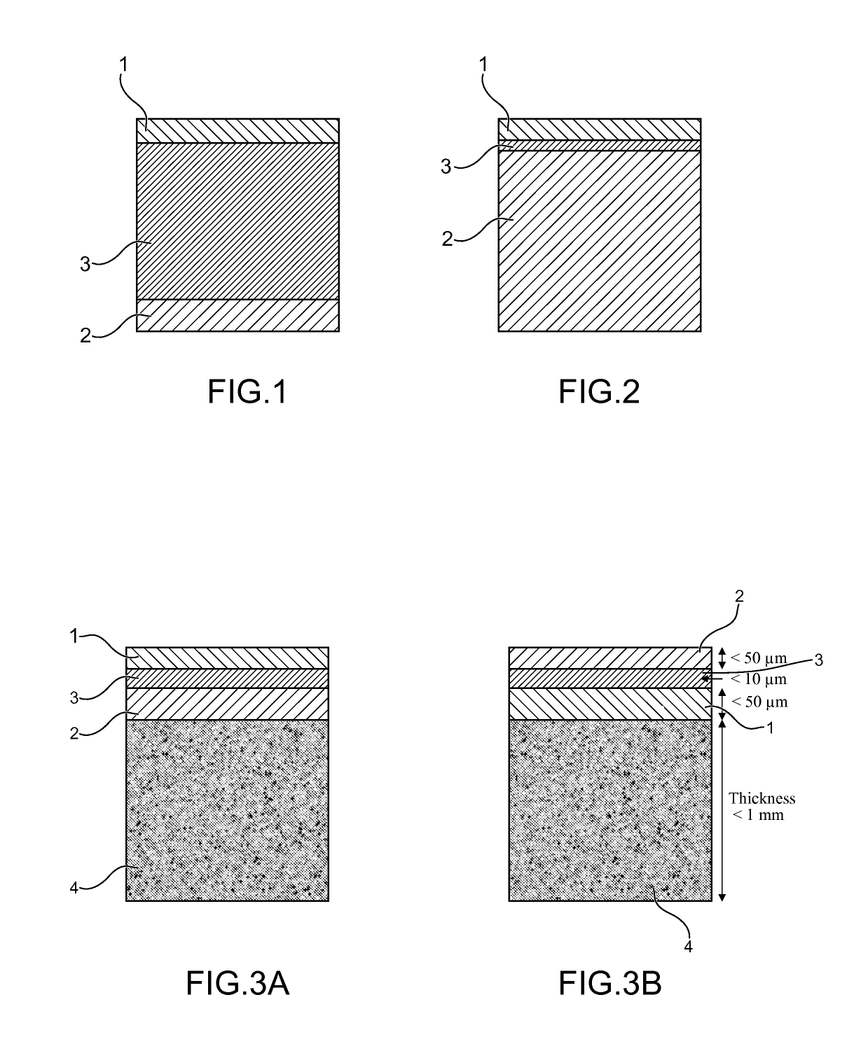

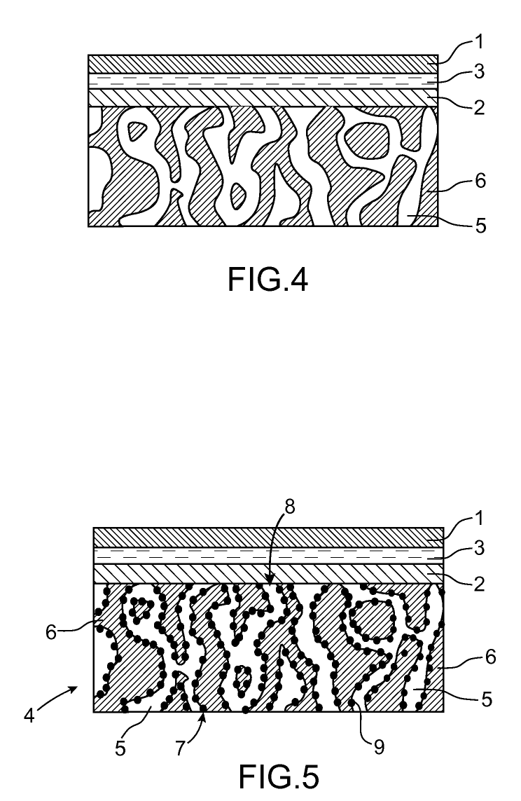

### DETAILED DESCRIPTION OF PARTICULAR EMBODIMENTS

The detailed description which follows is rather given, for ease, with reference to a process for preparing or manufacturing the cell according to the invention.

It is firstly specified that the term “porous” as it is used in the present text in relation to a material such as a metal or a metal alloy means that this material contains pores or voids.

Consequently, the specific gravity of this porous material is less than the theoretical specific gravity of the nonporous material.

The pores may be linked or separate, but in the porous metallic substrate according to the invention the majority of the pores are linked, in communication. This is then referred to as open porosity.

Generally, in the porous metallic support of the invention, the pores are percolating pores which link the first main surface (generally the lower surface) to the second main surface (generally the upper surface).

Within the meaning of the invention, a support is generally considered to be porous when its specific gravity is at most around 95% of its theoretical specific gravity.

Moreover, in the present text, the terms substrate and support are used without distinction, the term support tending to relate to the porous substrate integrated or that is going to be integrated into an SOFC.

The manufacture and preparation of a cell of a fuel cell according to the invention comprise a first step during which the porous metallic support is prepared, manufactured, produced.

The substrate or porous metallic support may have a main cross section in the shape of a polygon, for example a square or rectangular cross section or else a circular cross section.

The substrate is generally a flat or planar substrate, that is to say that the first and second surfaces mentioned above are generally flat, preferably horizontal and parallel and have, for example, one of the shapes mentioned above: polygon, rectangle, square or circle, and that, in addition, the thickness of the substrate is small relative to the dimensions of said first and second surfaces. More preferably, said first and second surfaces are horizontal surfaces and the first main surface may then be described as the lower surface whereas the second main surface may then be described as the upper surface.

The substrate may especially have the shape of a disc, for example having a thickness from 200 μm to 2 mm and having a diameter from 20 mm to 500 mm, or the shape of a rectangular parallelepiped or else the shape of a substrate having a square cross section.

The substrate may be a substrate of large size, namely, for example, having a diameter or side from 50 mm to 300 mm, or a substrate of small size, for example from 10 mm to 50 mm.

This porous metallic support may be manufactured by pressing, especially uniaxial pressing, then sintering or else by tape casting, these tapes then being assembled by thermocompression or lamination, then sintered.

The manufacture of a porous metallic support by uniaxial pressing is especially described in documents [18] and [19] to which reference may be made. The metal or alloy in powder form is optionally mixed with a pore-forming agent and an organic binder, the mixture is introduced into a mould of suitable shape, then it is shaped by uniaxial pressing.

The mould has a shape and a size that are adapted to the shape and to the size of the substrate that it is desired to prepare.

The mould is generally made of a metallic material.

The metallic powders introduced into the mould may be chosen from powders of the following metals and metal alloys: iron, iron-based alloys, chromium, chromium-based alloys, iron-chromium alloys, stainless steels, nickel, nickel-based alloys, nickel-chromium alloys, alloys containing cobalt, alloys containing manganese, and alloys containing aluminium.

The powders used in the process according to the invention may be commercial powders or else they may be prepared by milling or atomization of solid pieces of metals or alloys.

The powders of metals or alloys used in the process according to the invention generally have a particle size from 1 μm to 500 μm, preferably from 1 μm to 100 μm.

A porosity gradient may be obtained in the porous metallic support by varying the amount and/or particle size distribution of the pore forming agent and/or of the metal.

In order to obtain a porosity gradient of the porous metallic support according to the invention, it is possible to deposit successively in the mould at least two layers of powder, which have increasing, respectively decreasing, particle sizes.

Indeed, the greater the particle size of the powder, the higher the porosity of the pressed then sintered material resulting from this powder.

Thus, it is possible to begin by depositing into the mould a first or lower layer consisting of a powder of large particle size, namely for example from 50 μm to 500 μm, intended to form in the final porous metallic support, and after compression/pressing then sintering, a lower layer of high porosity, namely having a porosity generally from 25% to 65%, advantageously from 30% to 60%. In the final porous metallic support, this lower layer of high porosity makes it possible to facilitate the transport of the gases through the porous support.

The thickness of this lower layer consisting of a powder of large particle size is such that it gives, in the final porous support, a layer of high porosity having a thickness generally from 100 μm to 2 mm.

On top of this lower layer consisting of a powder of large particle size, it is possible to deposit a layer consisting of a powder of small particle size, namely for example from 1 μm to 50 μm, intended to form in the final porous metallic support, and after compression and sintering, an upper layer of low porosity, namely having a porosity generally from 10% to 40%, advantageously from 10% to 30%. In the final porous metallic support, this upper layer of low porosity makes it possible to facilitate the attachment of the ceramic layer forming the electrode.

The thickness of this upper layer consisting of a powder of small particle size is such that it gives, in the final porous support, a layer of low porosity having a thickness generally of less than 200 μm, and preferably of less than 100 μm.

Instead of depositing firstly a lower layer consisting of a powder of large particle size and then an upper layer consisting of a powder of small particle size, it is of course possible, conversely, to begin by depositing the layer consisting of a powder of small particle size then to deposit the layer consisting of a powder of large particle size.

One or more intermediate layer(s) consisting of powders having a particle size intermediate between the particle size of the powder constituting the lower, respectively upper, layer of large particle size and the particle size of the powder constituting the upper, respectively lower, layer of small particle size may be deposited between the lower layer and the upper layer.

These intermediate layers may number from 1 to 8, for example from 1 to 5, in particular 2, 3 or 4. The particle size of the powders which form these intermediate layers is advantageously chosen to ensure a more continuous progression of the porosity in the final porous metallic support. In other words, these intermediate layers are formed of powders having a particle size that decreases from the layer closest to the layer consisting of a powder of large particle size to the layer closest to the layer consisting of a powder of small particle size.

Thus, four intermediate layers could be provided, consisting of powders respectively having a particle size of 300 to 400 μm, 200 to 300 μm, 100 to 200 μm and 50 to 100 μm between a layer of large particle size generally having a particle size of 400 to 500 μm and a layer of small particle size generally having a particle size of 1 to 50 μm.

The exact porosity and thickness of the layers in the final porous metallic support are defined by the particle size of the powders and also by the force applied during the pressing step described below.

Moreover, all the layers of powders including the optional intermediate layers may consist of one and the same alloy or metal or else one or more layers of powders may consist of a metal or alloy different from the other layers.

Once the layers of powders have been placed in the mould, a step of shaping these powders is then carried out by pressing or compression. Prior to filling the mould, it is optionally possible to incorporate a binder, such as an organic binder of PVA type, and/or a pore forming agent of starch type. These compounds may be added to the metallic powder in the form of a suspension or of a powder (both having a content of 1 to 20%, preferably of 5% by weight). The incorporation of the binder makes it possible to obtain a sufficient mechanical strength of the pressed parts in the green state. The incorporation of the pore forming agent makes it possible to achieve the final porosity of the material.

The various layers are deposited by very simply pouring them into the mould, and the pressing and sintering are generally carried out on all of the layers as a single part. It is also possible to carry out the pressing and sintering layer by layer.

Preferably, this pressing, this compression is carried out using a uniaxial press.

During the pressing, a pressure between 10 and 700 MPa, preferably of 100 MPa, is generally applied in order to thus obtain a porosity from 70% to 20%, and preferably from 40% to 60% in the green state.

At the end of the step of shaping by pressing or compression, a “green” porous metallic support is obtained with an average overall porosity from 70% to 20%, preferably from 40% to 60%. The “green” porous metallic support or substrate is then separated from the mould.

It is also possible to prepare the “green” porous metallic support or substrate by tape casting then assembling via a thermocompression or lamination [20], [21].

The metal in powder form is suspended in an organic solvent, for example an azeotropic mixture of methyl ethyl ketone (MEK) and ethanol, using a suitable dispersant, such as oleic acid for example. Binders, and/or dispersants and/or plasticizers such as polyethylene glycol, or dibutyl phthalate are introduced, and also a pore forming agent such as a wax, a starch, or a polyethylene.

The suspension is cast in the form of a tape using a casting shoe.

After drying, the tape is cut up and may be assembled by thermocompression or lamination to other tapes optionally comprising different amounts and/or different particle size distributions of pore forming agent and/or of metal thus making it possible to obtain a porosity gradient after sintering.

Thermocompression makes it possible, under the combined action of the temperature and the pressure, to soften the binders and plasticizers contained in the tapes and to weld them together.

The next step of the process according to the invention consists in sintering this “green” porous metallic support.

The sintering of this “green” porous metallic support is preferably carried out under a controlled atmosphere, namely an atmosphere generally defined by a very low partial pressure of oxygen, for example of less than 10⁻²⁰ atm, in order to limit the oxidation of this porous support. This atmosphere generally consists of argon or nitrogen in the presence of a reducing agent such as hydrogen, or else of pure hydrogen.

The sintering is generally carried out at a temperature between the minimum sintering start temperature and the complete densification temperature of the material constituting the “green” porous support. This temperature is generally from 600° C. to 1600° C. and it is more specifically from 800° C. to 1400° C., in particular for steel 1.4509.

Preferably, the sintering temperature corresponds to 85% of the complete densification temperature of the material, namely for example 1200° C.

The sintering temperature may be maintained (sintering plateau) for a duration from 0 to 8 hours, for example of 3 hours.

The choice of the densification-sintering temperature and also the duration of the sintering plateau will be governed by the desired overall average final porosity of the material and preferably a sintering temperature of 1200° C. will be chosen, which will be maintained for a duration of 3 hours.

It has been seen that it is preferred to press and sinter all the layers as a single part but when each layer consists of a different material and/or has a different particle size, each of these layers also has different sintering temperatures and/or durations and/or sintering plateaux. The man skilled in the art will then easily be able to determine the sintering temperatures, durations and plateaux for all of the layers by means of a few preliminary tests.

Next, in the following step of the process for preparing a cell of a fuel cell according to the invention, the metallic porous support is functionalized so that it fulfils its direct internal reforming role.

For this, it is optionally possible to provide the porous metallic support with a “protective barrier” for protecting the anode with respect to sulphur-containing compounds such as hydrogen sulphide (sulphur resistance) and oxygen (oxygen resistance).

In order to protect the anode from sulphur-containing compounds such as the hydrogen sulphide contained in the feed gas, or from oxygen when the anode is exposed to air, a porous metal layer, for example a layer of nickel, of copper, of manganese, of cobalt, of iron, or of an alloy thereof may be combined with the porous metallic support.

In order to do this, this layer may be directly produced during the manufacture of the metallic support by the two processes mentioned previously. In the case of the pressing, it is sufficient to arrange, as first layer, a mixture composed of metal powder, for example nickel powder, pore forming agents and binders, then to add the constituent layers of the porous metallic support which may or may not have a porosity gradient.

In the case of the casting of tapes assembled by thermocompression or lamination, it is sufficient to arrange an additional tape containing a metal such as nickel and pore forming agents before the assembly. Sintering under a neutral atmosphere will mechanically strengthen the complete structure.

In any case, the functionalization comprises a step that consists in providing the porous metallic support with a catalytic function for the direct internal reforming (DIR). This catalytic function is provided by a catalyst, such as a steam reforming catalyst distributed in the porous metallic support. This catalyst may be supported, impregnated on a solid support. A nonlimiting example of such a catalyst is a steam reforming catalyst such as a gadolinated ceria impregnated by a noble metal. The following description of the preparation of the porous metallic support provided with a catalyst has been provided under the assumption that this catalyst is gadolinium-doped ceria impregnated by a noble metal, but the man skilled in the art will easily be able to transpose and adapt this process to other catalysts, whether or not they are supported.

Gadolinium-doped ceria (CGO) impregnated by a noble metal such as platinum is known for ensuring the catalysis of reforming reactions and for having an increased resistance to hydrogen sulphide.

An addition of doped ceria impregnated by a noble metal (CGO/noble metal) to the porous metallic support may be carried out in various ways:
It is possible to introduce a powder of CGO/noble metal into the pressing or tape-casting formulations. It is thus optionally possible to vary the concentration of catalyst in the volume of the porous support.
It is possible to introduce the catalyst into the metallic support in the form of a solution or of a suspension containing said catalyst [22, 23], by successive impregnations of the previously sintered porous metallic support.
It is then optionally possible to create a CGO/noble metal concentration gradient by carrying out a different number of impregnations according to the zones to be enriched or to be depleted.

A subsequent heat treatment converts the organometallic precursor to metal such as platinum.

Once the porous metallic support comprising a catalyst is prepared, the manufacture of the cell of a fuel cell according to the invention is completed by depositing onto the porous metallic support initially produced then sintered as was described above, the anode (2) then the electrolyte (3) and then the cathode (1).

Within the context of a metal-supported cell, the electrolyte is generally a layer having a thickness of 5 to 30 μm, preferably from 5 to 20 μm, for example of the order of 10 μm.

The anode and the cathode are generally layers having a thickness between 30 and 60 μm, for example of the order of 40 μm.

The layers of the cell are then generally sintered successively or in a single step depending on the nature of the materials and the respective sintering temperature thereof.

FIGS. 5, 6 and 7 present cells of a fuel cell according to the invention which comprise a porous metallic support (4), with defined pores (5) in a metallic matrix (6).

The support represented in FIG. 5 is a generally flat support with a first flat main surface (7) and a second flat main surface (8), these two surfaces (7, 8) being parallel. These two surfaces (7, 8) are generally horizontal, the first main surface (7) then being a lower surface and the second main surface (8) then being an upper surface, preferably the distance between the two main surfaces (7, 8) is from 400 to 500 μm as shown by way of example in FIG. 7.

This metallic porous support is infiltrated by a powder consisting of particles of catalyst (9), preferably a Pt/Ce_{0.8}Gd_{0.2}O_{1.9} catalyst, which are generally deposited on the walls of the pores (5). Stacked on this porous support are, in a conventional manner, an anode layer (2) for example made of Ni-8YSZ cermet, and preferably made of Ni-CGO cermet, an electrolyte layer (3) preferably based on stabilized zirconia, and a cathode layer (1) preferably made of LSM.

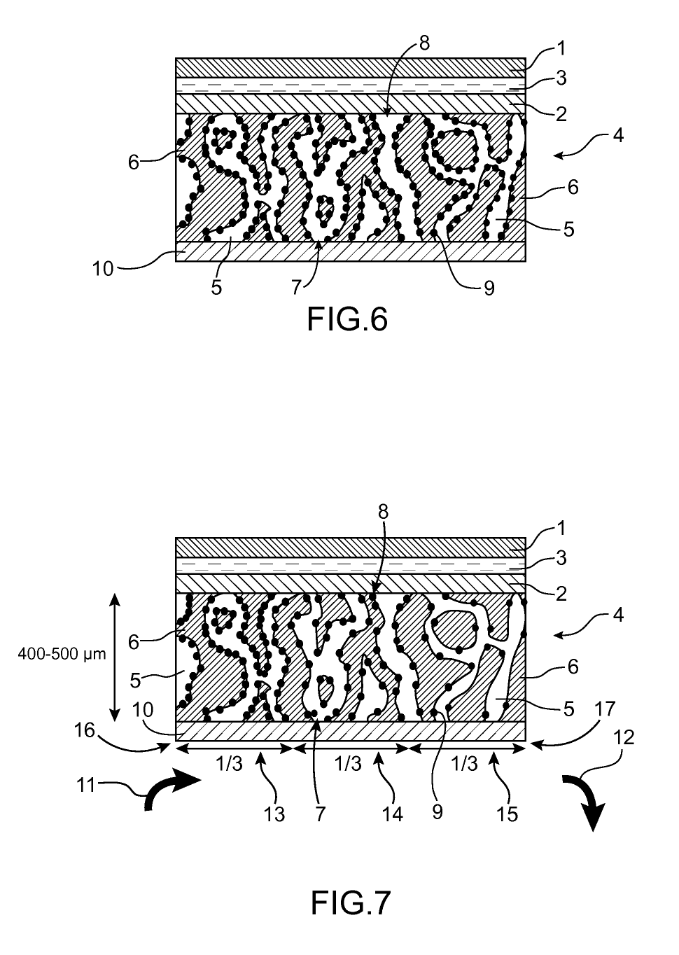

In FIG. 6, the cell also comprises a porous layer of metal, for example of pure nickel (10) for example having a thickness from 10 to 20 μm, on the lower surface (7) of the porous metallic support.

In FIG. 7, the cell comprises a porous nickel layer (10) and in addition the catalyst is distributed with a longitudinal gradient in the porous metallic support from the inlet for the hydrocarbon feed (11) to the outlet for discharging the reforming products of these hydrocarbons (12), in other words from the inlet (11) to the outlet (12) of the gases.

Between said inlet (11) and said outlet (12) the flow, feed stream of hydrocarbon circulates in a channel on the outside of the cell and along the first main surface (7) which is, in the figure, the lower surface of the porous support (4). This feed stream is gradually enriched with reforming product before being discharged via the outlet (12) of this stream.

The expression “longitudinal gradient” is understood to mean this gradient is generally established along the largest dimension of the porous metallic support.

This gas inlet (11) is generally located at a first end (16) of the porous metallic support whereas the gas outlet (12) is generally located at another or second end (17) of the porous metallic support.

In FIG. 7, the porous metallic support is thus divided into three successive zones (13, 14, 15), having substantially equal volumes, in the direction of its largest dimension, namely its length (in the case of a rectangular support) or its radius (in the case of a circular support).

The cell is divided into 3 zones from the gas inlet in the direction of the discharge point (for example from one of the edges or end (16) of the cell to the other of the edges or end (17) in the case of a rectangular cell). In the second and third zones (14, 15) the amount of catalyst is halved relative to the preceding zone.

The cell represented in FIG. 7, in the case where the anode (2) is made of an Ni-CGO cermet, may be considered to be a cell that generally gives the best results for a better resistance to “redox” cycles, a greater resistance to sulphur and an optimization of the amount of catalysts used.

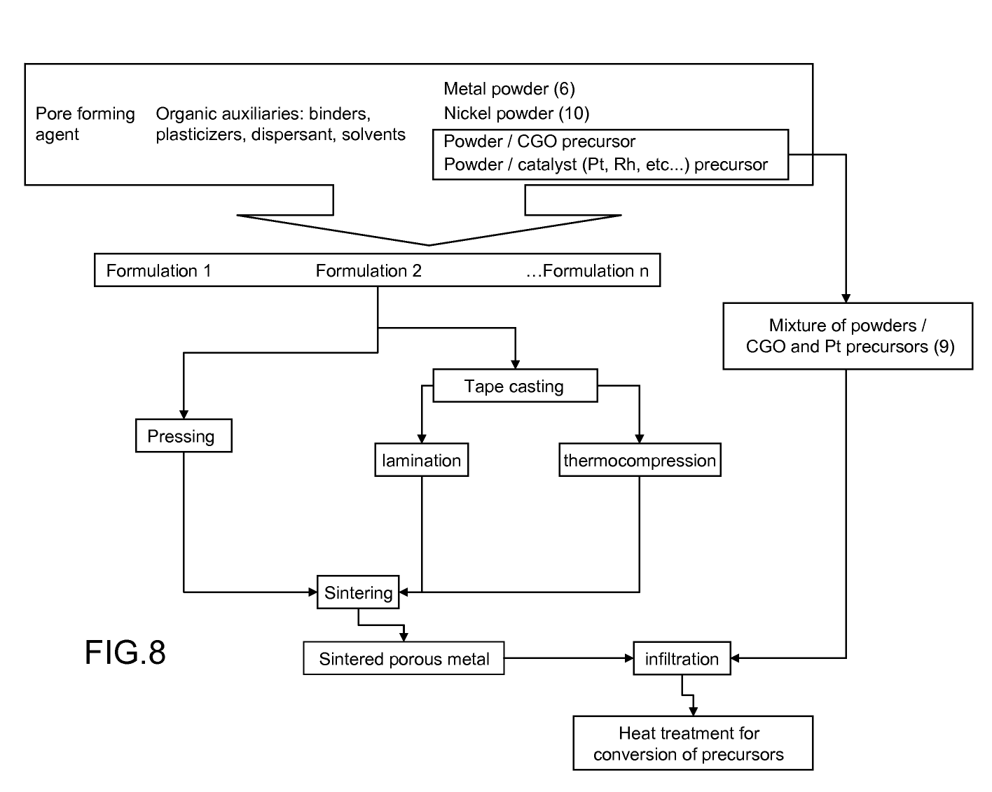

FIG. 8 presents a flow chart describing the various pathways for producing the “functionalized” porous metallic support.

It is important to note that the flow chart of FIG. 8 only constitutes one embodiment, given by way of example, of the process for manufacturing the cell having the architecture according to the invention.

Other embodiments of this process are possible.

For example, it could be envisaged to sinter the metallic porous support and the layers of the cell directly together in a single step. In this embodiment, the metal support could then be directly impregnated by the catalyst, such as a steam reforming catalyst (CGO/Pt for example).

The SOFC comprising a cell according to the invention in particular finds its application in the field of micro-cogeneration. It is possible, for example, to use this cell architecture in a fuel cell fed by natural town gas and that is integrated into an individual boiler for a simultaneous production of electricity and heat.

An SOFC comprising a cell according to the invention may also function by being supplied with biogas, resulting for example from the treatment of waste from landfill or from wastewater treatment plants, or with gas resulting from the treatment of various effluents, for example paper-making or dairy effluents.

### REFERENCES

[1] N. Christiansen et al., Solid Oxide Fuel Cell Research and Development at Topsoe Fuel Cell A/S and Risø/DTU, 8^{th} European Fuel Cell Forum 2008, Lucerne, Switzerland, 30 Jun. to 4 Jul. 2008, article B0201.
[2] P. Attryde, A. Baker, S. Baron, A. Blake, N. P. Brandon, D. Corcoran, D. Cumming, A. Duckett, K. El-Koury, D. Haigh, M. Harrington, C. Kidd, R. Leah, G. Lewis, Stacks and system based around metal-supported SOFCs operating at 500-600° C., in: Proceedings of SOFC IX, the Electrochemical Soc., Quebec, Canada (2005), vol. 1, pp. 113-122.
[3] Y. B. Matus, L. C. De Jonghe, C. P. Jacobson, S. J. Visco, Metal-supported solid oxide fuel cell membranes for rapid thermal cycling, Solid State Ionics, 176, 2005, pp. 443-449.
[4] M. C. Tucker, G. Y. Lau, C. P. Jacobson, L. C. De Jonghe, S. J. Visco, Metal-supported SOFCs, in: Proceedings of SOFC X, ECS transaction, Nara, Japan (2007), vol. 7(1), pp. 279-284.
[5] M. C. Tucker, G. Y. Lau, C. P. Jacobson, L. C. De Jonghe, S. J. Visco, Stability and robustness of metal-supported SOFCs, J. Power Sources, 175, 2008, pp. 447-451.
[6] S. C. Tsang, J. B. Claridge, M. L. H. Green, Recent advances in the conversion of methane to synthesis gas, Catalysis Today, 23, 1995, pp. 3-5.
[7] K. Ahmed, K. Foger, Kinetics of internal steam reforming of methane on Ni/YSZ based anodes for solid oxide fuel cells, Catalysis Today, 63 (2000) 479-487.
[8] M. Krumpelt, T. R. Krause, J. D. Carter, J. P. Kopasz and S. Ahmed, Fuel processing for fuel cell systems in transportation and potable power applications, Catalysis Today, 77, 2002, pp. 3-16.
[9] Y. Lu, J. Chen, Y. Liu, Q. Xue and M. He, Highly sulphur-tolerant Pt/Ce_{0.8}Gd_{0.2}O_{1.9} catalyst for steam reforming of liquid hydrocarbons in fuel cell applications, Journal of catalysis, 254, 2008, 39-48.
[10] U.S. Pat. No. 6,051,329.
[11] Y. Matsuzaki and I. Yasuda, The poisoning effect of sulfur-containing impurity gas on a SOFC anode: Part I. Dependance on temperature, time and impurity concentration, Solid State Ionics, 132, 2000, pp. 261-269.
[12] J. Mougin, S. Ravel, E. de Vito and M. Petitjean, Influence of fuel contaminants on SOFC operation: effect on performance and degradation mechanisms, in: Proceedings of SOFC X, ECS transaction, Nara, Japan (2007), vol. 7(1), pp. 459-468.
[13] J. Laurencin, F. Lefebvre-Joud and G. Delette, Impact of cell design and operating conditions on the performances of SOFC fuelled with methane, J. Power Sources, 177, 2008, pp. 355-368.
[14] U.S. Pat. No. 5,496,655.
[15] US-A1-2005/0170234.
[16] US-A1-2007/0015015.
[17] J. Laurencin, G. Delette, F. Lefebvre-Joud and M. Dupeux, A numerical tool to estimate SOFC mechanical degradation: case of the planar cell configuration, J. Euro. Ceram. Soc., 28, 2008, pp. 1857-1869.
[18] Preparation of Porosity-Graded SOFC Anode Substrates, Fuel Cells, Volume 6, Issue 2, April, 2006, Pages: 113-116, P. Holtappels, C. Sorof, M. C. Verbraeken, S. Rambert, U. Vogt.
[19] Dry Powder Deposition and Compaction for Functionally Graded Ceramics, Journal of the American Ceramic Society, Volume 89, Issue 11, November 2006, Pages: 3406-3412, Zachary N. Wing, John W. Halloran.
[20] Tape Casting of Al₂O₃/ZrO₂ Laminated Composites, Journal of the American Ceramic Society, Volume 69, Issue 8, August 1986, Pages: C-191-C-192, Philippe Boch, Thierry Chartier, Muriel Huttepain.
[21] Processing of Tape-Cast Laminates Prepared from Fine Alumina/Zirconia Powders, Journal of the American Ceramic Society, Volume 77, Issue 8, August 1994, Pages: 2145-2153, Kevin P. Plucknett, Carlos H. Càceres, Christopher Hughes, David S. Wilkinson.
[22] Direct Formation of Crystalline Gadolinium-Doped Ceria Powder via Polymerized Precursor Solution, Journal of the American Ceramic Society, Volume 85, Issue 7, July 2002, Pages: 1750-1752, Shuqiang Wang, Kunihiro Maeda, Masanobu Awano.
[23] EP-A1-1 920 833

1. A cell of a solid oxide fuel cell (SOFC) with internal reforming of hydrocarbons, in which said cell is a metal-supported cell comprising:
a porous metallic support comprising pores having walls, said porous support (4) comprising a first main surface and a second main surface;
an anode adjacent to said second main surface (8);
an electrolyte adjacent to said anode; and
a cathode adjacent to said electrolyte;
a catalyst for reforming at least one hydrocarbon being deposited on the walls of the pores of the porous metallic support, and an amount, concentration of catalyst in the porous metallic support decreasing in a direction of the first main surface in a same direction as a flow direction of a hydrocarbon feed stream, along said first main surface on the outside of the cell.

2. The cell of a fuel cell according to claim 1, in which the first main surface and the second main surface are flat and parallel surfaces.

3. The cell of a fuel cell according to claim 2, in which the first main surface is a lower surface and the second main surface is an upper surface, and the anode, the electrolyte and the cathode are successively stacked on the second main surface (8) of the porous metallic support.

4. The cell of a fuel cell according to claim 1, in which a porosity of the porous metallic support is from 20 to 70%.

5. The cell of a fuel cell according to claim 1, in which an average diameter of the pores of the porous metallic support is from 1 to 50 μm.

6. The cell of a fuel cell according to claim 1, in which a distance between the first main surface and the second main surface of the porous metallic support is from 200 to 1000 μm.

7. The cell of a fuel cell according to claim 1, in which an amount of catalyst is from 0.1 to 5% by weight relative to a weight of the porous metallic support.

8. The cell of a fuel cell according to claim 1, in which the catalyst is a steam reforming catalyst.

9. The cell of a fuel cell according to claim 8, in which the catalyst is selected from the group consisting of transition metals, noble or precious metals, and mixtures thereof.

10. The cell of a fuel cell according to claim 8, in which the catalyst is supported, impregnated on a solid support.

11. The cell of a fuel cell according to claim 10, in which the solid support of the catalyst is selected from the group consisting of optionally doped metal oxides, strontium-doped lanthanum chromite, and ceria, optionally doped with gadolinium, samarium or yttrium.

12. The cell of a fuel cell according to claim 11, in which the catalyst is a noble metal.

13. The cell of a fuel cell according to claim 1, in which the catalyst is in the form of particles.

14. The cell of a fuel cell according to claim 1, in which an amount, concentration of catalyst decreases continuously or in decrements in the porous metallic support from a first end of the latter where an inlet for the feed stream of said hydrocarbon is located to a second end of the latter where an outlet for discharging a stream of at least one reforming product is located.

15. The cell according to claim 14, in which the porous metallic support is divided into n successive zones from said first end to said second end, an amount of catalyst being decreased each time, preferably divided by an integer, from one zone to the next.

16. The cell according to claim 15, in which the porous metallic support is divided into a first, a second and a third successive zones, preferably of equal volume, from said first end to said second end, the amount of catalyst in said second zone, respectively third zone, being half of the amount of catalyst in said first zone, respectively second zone.

17. The cell of a fuel cell according to claim 1, in which a porosity of the porous metallic support decreases from the first main surface to the second main surface, and the support may then comprise, from the first main surface to the second main surface, at least one layer of high porosity in contact with the first main surface (7) and a layer of low porosity in contact with the second main surface.

18. The cell of a fuel cell according to claim 1, comprising, in addition, a porous layer made of a metal selected from the group consisting of nickel, copper, manganese, cobalt, iron and alloys thereof, deposited on the first main surface.

19. The cell of a fuel cell according to claim 1, in which the porous metallic support is made of a metal or alloy selected from the group consisting of iron, iron-based alloys, chromium, chromium-based alloys, iron-chromium alloys, stainless steels, nickel, nickel-based alloys, nickel-chromium alloys, alloys containing cobalt, alloys containing manganese, aluminium, and alloys containing aluminium.

20. The cell of a fuel cell according to claim 1, in which the anode is made of a cermet of nickel and of yttrium oxide-stabilized zirconia (YSZ), or of a cermet of nickel and of ceria stabilized or doped with scandium, ytterbium or gadolinium oxide (CGO).

21. The cell of a fuel cell according to claim 1, in which a porosity of the porous metallic support 40%.

22. The cell of a fuel cell according to claim 1, in which an average diameter of the pores of the porous metallic support is from 5 to 15 nm.

23. The cell of a fuel cell according to claim 1, in which an average diameter of the pores of the porous metallic support is 6 nm.

24. The cell of a fuel cell according to claim 1, in which a distance between the first main surface and the second main surface of the porous metallic support is from 400 to 500 nm.

25. The cell of a fuel cell according to claim 8, wherein the transition metals are selected from the group consisting of nickel, cobalt, copper, chromium and iron, and the noble or precious metals are selected from the group consisting of ruthenium, platinum, rhodium, silver, iridium and palladium.

26. The cell of a fuel cell according to claim 11, wherein the optionally doped metal oxides is alumina.

27. The cell of a fuel cell according to claim 11, wherein the noble metal is platinum supported by gadolinium-doped ceria (CGO).
